(19) United States
(12) Patent Application Publication
(10) Pub. No.: US 2026/0153430 A1
(43) Pub. Date: Jun. 4, 2026

(54) SURFACE POLLUTION ENVIRONMENT PRECISION SIMULATION SYSTEM USING UNIFORM DROPLET DROPPING AND CONTROLLING METHOD FOR THE SAME

(71) Applicant: AGENCY FOR DEFENSE DEVELOPMENT, Daejeon (KR)

(72) Inventors: Young Su JEONG, Daejeon (KR); Young Jin KOH, Daejeon (KR); Sang Soo HAN, Daejeon (KR); Jung Ho LEE, Daejeon (KR); Jae Hwan LEE, Daejeon (KR); Sun Kyung CHOI, Daejeon (KR)

(21) Appl. No.: 19/293,644

(22) Filed: Aug. 7, 2025

(30) Foreign Application Priority Data
Nov. 29, 2024 (KR) 10-2024-0174570

(51) Int. Cl. G01N 17/00; B05B 12/08

(52) U.S. Cl. CPC G01N 17/002; B05B 12/08

(57) ABSTRACT

There are provided a surface pollution environment precision simulation system using uniform droplet dropping and a control method for the same, which is capable of precisely simulating and controlling a field pollution environment required in test and evaluation procedures for chemical agents or the like by controlling an inkjet-type droplet generation device so that uniform droplet dropping is performed within a contaminated area according to set conditions. Furthermore, by precisely controlling variables such as spraying amount, droplet size, spraying frequency, and software operation of the simulation equipment to implement a surface pollution environment of a chemical agent required in the test and evaluation, it is possible not only to prevent residual amounts from remaining at the equipment outlet but also to significantly improve the efficiency and reliability of the test and evaluation method for measuring the performance of surface chemical agent detection equipment and devices.

### CROSS-REFERENCE TO RELATED APPLICATION

This application claims priority to Korean Patent Application No. 10-2024-0174570 filed on Nov. 29, 2024, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to a surface pollution environment precision simulation system using uniform droplet dropping and a control method for the same. In particular, the present disclosure relates to a surface pollution environment precision simulation system using uniform droplet dropping and a control method for the same, which is capable of precisely simulating and controlling a field pollution environment required in test and evaluation procedures for chemical agents or the like, by controlling an inkjet-type droplet generation device such that the uniform droplet dropping is performed within a contaminated area according to set conditions.

### Description of the Related Art

In general, chemical agent contamination in the field occurs through various dissemination means, primarily by being sprayed and dropped onto the surface in the form of droplets, thereby contaminating the surface. Subsequently, the chemical agent volatilizes and diffuses in a vapor state, contaminating the atmosphere. Such contaminated areas and environments can restrict the movement of personnel and equipment and may serve as invisible obstacles due to the spread of contamination.

Therefore, reconnaissance and overcoming of contaminated areas are critically important. For this purpose, there have been introduced systems such as the Joint Contaminated Surface Detector (JCSD), which is developed to detect and identify liquid agents on surfaces while in motion. The JCSD is equipment that measures Raman scattering signals from chemical substances in the form of droplets. Such measurement equipment irradiates ultraviolet laser onto the surface during movement to obtain characteristic Raman scattering signals from chemical substances present on the surface in droplet form, thereby enabling the detection and verification of the presence of chemical substances.

However, in order to verify the performance of the surface contamination detection equipment as described above under chemical, biological, and radiological warfare conditions, it is generally necessary to use a test and evaluation method for measuring the performance of surface chemical agent detection equipment. For this purpose, a device that simulates a field environment is used, which constructs a virtual surface contamination area by spraying fine liquid particles onto the surface at high speed in a manner similar to field conditions through a droplet dropping device.

Therefore, in the test and evaluation procedures as described above, chemical agents or industrial toxic substances are applied using mist spraying devices or liquid particle spraying devices as test and evaluation methods for measuring the performance of surface chemical agent detection equipment. Such devices spray the substances onto a designated surface before conducting the test. For accurate testing and evaluation of the equipment, it is essential that the contamination environment is simulated with the target particle size and distribution.

In such test and evaluation procedures, performance requirements for surface chemical agent detection equipment, as developed in advanced countries, generally set the target detection concentration at a minimum of 0.5 g/m², with moderate contamination defined as 1 g/m² and severe contamination as 10 g/m². In particular, in reported cases regarding surface contamination at the 0.5 g/m² level, droplets with an average diameter of 0.5 mm are sprayed from the air onto the surface at a distribution of approximately one droplet per m². The size of each deposited droplet in this case is reported to be approximately 3 mm. In other words, in test and evaluation, contamination environment construction is determined by droplet size and density (frequency), and a methodology capable of implementing this is required.

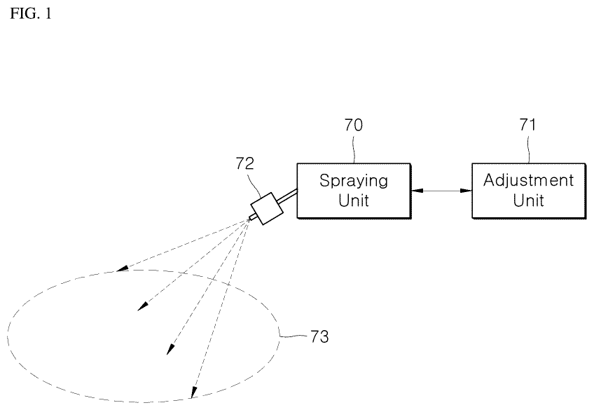

Referring to FIG. 1, a conventional surface pollution environment simulation device as described above includes:
a spraying unit 70 that sprays a simulated agent;
an adjustment unit 71 that controls the droplet state of the simulated agent sprayed onto the surface 73 by the spraying unit 70; and
a nozzle unit 72 installed at the front end of the spraying unit 70, which controls the spraying of the simulated agent according to adjustments by the adjustment unit 71.

Meanwhile, as operation of the conventional surface pollution environment simulation device, in order to verify the performance of surface contamination measurement equipment under chemical, biological, and radiological warfare conditions, a test and evaluation method is generally used to measure the performance of surface chemical agent detection equipment. In this process, a surface pollution environment simulation device that simulates a field environment is used to spray fine liquid particles at high speed onto the surface 73 in a manner similar to field conditions, thereby constructing a virtual surface contamination area.

At this time, the nozzle unit 72 of the spraying unit 70 of the surface pollution environment simulation device is positioned over the surface 73 for test evaluation, and the spraying unit 70 is operated to spray the simulated agent onto the surface 73 through the nozzle unit 72. During this process, the adjustment unit 71 finely adjusts the droplet state of the simulated agent sprayed onto the surface 73 by the spraying unit 70, so that performance testing and evaluation can be carried out under the required droplet conditions.

However, the conventional surface pollution environment simulation device as described above, for example, configures a complex device to generate fine droplets of chemical substances including water. In this process, liquid chemical agents have high viscosity and low surface tension, making them hydrophobic liquids with strong toxicity. As a result, residual amounts of the chemical agent remain at the outlet of the equipment when generating droplets, making it extremely difficult to achieve precision.

Even if a droplet dispenser device utilizing an electronic microvalve and a droplet dropping method employing such a device is used, controlling the jet nozzle, pneumatic pressure, and the on/off timing of the valve to finely adjust trace amounts of highly viscous and low surface tension chemical agents, the distribution of droplet sizes remains relatively simple. This creates a significant problem in that it is very difficult to establish a surface pollution environment simulating a field environment that represents the contamination level definitions required for test and evaluation.

### RELATED PATENT DOCUMENT

Korean Registered Patent No. 10-2583100

### SUMMARY OF THE DISCLOSURE

The purpose of the present disclosure, which aims to solve the aforementioned conventional problems, is to provide a surface pollution environment precision simulation system using uniform droplet dropping and a control method for the same, which is capable of precisely simulating and controlling a field pollution environment required in test and evaluation procedures for chemical agents or the like by controlling an inkjet-type droplet generation device so that uniform droplet dropping is performed within a contaminated area according to set conditions.

In addition, the purpose of the present disclosure is to provide a surface pollution environment precision simulation system using uniform droplet dropping and a control method for the same, which is capable of significantly improving the efficiency and reliability of a test and evaluation method for measuring the performance of surface chemical agent detection equipment and devices by precisely controlling and implementing a surface pollution environment of a chemical agent required in the test and evaluation through variable control such as spraying amount, droplet size, spraying frequency, and software operation of the simulation equipment, thereby preventing residual amounts from remaining at the equipment outlet.

In order to achieve the purpose, an aspect of the present disclosure provides a surface pollution environment precision simulation system using uniform droplet dropping, comprising:
a spray nozzle unit configured to spray liquid onto a surface under a spraying condition set to simulate a pollution environment;
a spray nozzle injection control module configured to set and control the spraying condition of a simulated chemical agent for test evaluation through the spray nozzle unit, the spraying condition including at least one selected from the group consisting of droplet size and spraying frequency;
a pressure control module configured to control pressure of the liquid sprayed by the spray nozzle unit;
a pressure supply unit configured to supply the pressure to the spray nozzle unit via the pressure control module; and
a main control unit configured to comprehensively control functions of the surface pollution environment precision simulation system including the spray nozzle injection control module.

In some exemplary embodiment, the spray nozzle injection control module may further include a droplet spraying condition setting function configured to set factors including at least one selected from the group consisting of needle lift, needle rising time, nozzle open time, droplet falling time, delay, and drop count, for adjusting droplet size and spraying frequency, and the spray nozzle injection control module may be operated and controlled depending on the factors to adjust the droplet size and the spraying frequency.

In some exemplary embodiment, the spray nozzle injection control module may further include a spraying amount adjustment function configured to adjust a spraying amount, and in the spraying amount adjustment function, the liquid may be sprayed in a grid structure of a uniform size depending on setting of variables.

In some exemplary embodiment, the spraying amount adjustment function may further include a grid structure setting function configured to set X-axis size and Y-axis size of the grid structure,
the grid structure setting function may control the variables including at least one selected from the group consisting of delay, grid distance, and grid size,
the delay may refer to a time interval at which the liquid is sprayed,
the grid distance may refer to a physical spacing at which the liquid is sprayed, and
the grid size may refer to a number of times the liquid is sprayed to form the grid structure.

In some exemplary embodiment, the main control unit may further include a droplet control function configured to control a form and a range of droplets sprayed, and
the droplet control function may include at least one selected from the group consisting of a general mode, a grid mode, and an in-flight dosing mode.

In some exemplary embodiment, the main control unit may further include a precision simulation control function configured to control functions of the spray nozzle injection control module and the pressure control module, and
in the precision simulation control function, the spraying condition is set such that an amount of the liquid dropped per unit area (m²) is any one of 0.5 g, 1 g, 3 g, or 10 g, and a sensor module unit is provided to detect and confirm reproducibility, in order to precisely simulate the pollution environment for test evaluation on the surface.

In some exemplary embodiment, the surface pollution environment precision simulation system may use a surface contamination simulation automatic droplet dropping device (Autodrop Compact) to simulate a contamination environment sprayed with a liquid agent.

In some exemplary embodiment, a spraying angle of the spray nozzle unit may be controlled by a hinge driving means, and the hinge driving means may be controlled by the spray nozzle injection control module.

In some exemplary embodiment, wherein the main control unit may further include a spraying pressure control function configured to supply a set pressure to the spray nozzle unit via the pressure control module by the pressure supply unit, and simultaneously drive the pressure control module to control the pressure of the liquid sprayed by the spray nozzle unit according to set conditions.

In some exemplary embodiment, the spray nozzle unit and the spray nozzle injection control module may be configured as a droplet dispenser module including at least one selected from the group consisting of inkjet, jet, mono, and screw types.

In some exemplary embodiment, a plurality of sensor module units may be provided at one side of the pressure supply unit and the spray nozzle unit, and
the plurality of sensor module units may be configured to detect pressure supply by the pressure supply unit, spraying by the spray nozzle unit, or reproducibility of droplets simulated on the surface, and to transmit the detected information to the main control unit.

In addition, in order to achieve the purpose, another aspect of the present disclosure provides a control method for a surface pollution environment precision simulation system using uniform droplet dropping, comprising:
a first step of activating, by a main control unit, driving of a spray nozzle injection control module and a sensor module unit for test evaluation to measure performance of a surface chemical agent detection device;
a second step of setting, after the first step, by the main control unit, preset conditions for adjusting droplet size and spraying frequency of a simulated chemical agent for test evaluation through the spray nozzle injection control module, and controlling the spray nozzle injection control module to execute the preset conditions; and
a third step of controlling, after the second step, by the main control unit, a spray nozzle unit to spray a set liquid onto a surface under a spraying condition set to simulate a pollution environment through the spray nozzle injection control module.

In some exemplary embodiment, the second step may further include a droplet spraying condition setting step.

In the droplet spraying condition setting step, under control of the main control unit, the spray nozzle injection control module may set factors including at least one selected from the group consisting of needle lift, needle rising time, nozzle open time, droplet falling time, delay, and drop count, for adjusting droplet size and spraying frequency, and
the spray nozzle injection control module may be operated and controlled depending on the factors to adjust the droplet size and the spraying frequency.

In some exemplary embodiment, the second step may further include a spraying amount adjustment step.

In the spraying amount adjustment step, under control of the main control unit, the spray nozzle injection control module performs adjustment of a spraying amount.

In some exemplary embodiment, the spraying amount adjustment step may further include a grid structure control step.

In the grid structure control step, when spraying the liquid, the liquid may be sprayed in a grid structure of a uniform size depending on variable settings, and
the grid structure may be controlled based on variables including at least one selected from the group consisting of delay, grid distance, and grid size.

In some exemplary embodiment, the grid structure control step further may include a grid structure setting step of setting X-axis size and Y-axis size of the grid structure.

In the grid structure setting step, the liquid may be sprayed at a time interval set in the delay, at a physical spacing set in the grid distance, and a number of times set in the grid size.

In some exemplary embodiment, the second step may further include a spraying angle adjustment step.

In the spraying angle adjustment step, under control of the main control unit, a spraying angle of the spray nozzle unit may be adjusted by movement of a hinge driving means controlled by the spray nozzle injection control module mounted at one side of a fixing assembly.

In some exemplary embodiment, the third step further may include a spraying pressure control step.

In the spraying pressure control step, the main control unit may supply a set pressure to the spray nozzle unit via the pressure control module by the pressure supply unit, and may simultaneously drive the pressure control module to control the pressure of the liquid sprayed by the spray nozzle unit according to set conditions.

In some exemplary embodiment, the third step further may include a droplet control step in which the main control unit includes a droplet control function configured to control a form and a range of droplets sprayed.

Here, the droplet control function may include at least one selected from the group consisting of a general mode, a grid mode, and an in-flight dosing mode.

In some exemplary embodiment, the third step may further include a precision simulation control step in which the main control unit controls functions of the spray nozzle injection control module and the pressure control module to set the spraying condition such that an amount of the liquid dropped per unit area (m²) is any one of 0.5 g, 1 g, 3 g, or 10 g.

In the precision simulation control step, the main control unit may detect and confirm reproducibility through the sensor module unit to precisely simulate a pollution environment for test evaluation on the surface.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to the present disclosure, by controlling an inkjet-type droplet generation device such that uniform droplet dropping is performed within a contaminated area according to set conditions, it is possible to precisely simulate and control a field pollution environment required in test and evaluation procedures for chemical agents or the like.

Furthermore, according to the present disclosure, by precisely controlling and implementing a surface pollution environment of a chemical agent required in test and evaluation through variable control such as spraying amount, droplet size, spraying frequency, and software operation of the simulation equipment, residual amounts do not remain at the equipment outlet, thereby significantly improving the efficiency and reliability of a test and evaluation method for measuring the performance of surface chemical agent detection equipment and devices.

### BRIEF DESCRIPTION OF THE DRA WINGS

FIG. 1 is a view illustrating an example of a conventional system.

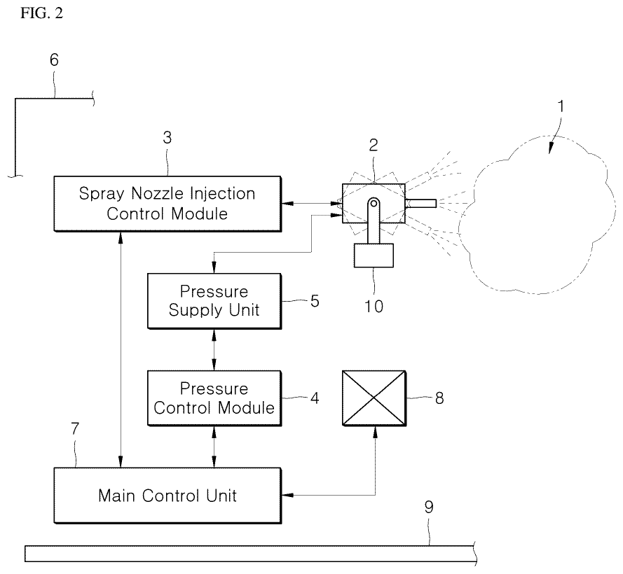

FIG. 2 is a conceptual diagram illustrating a surface pollution environment precision simulation system using uniform droplet dropping according to an exemplary embodiment of the present disclosure.

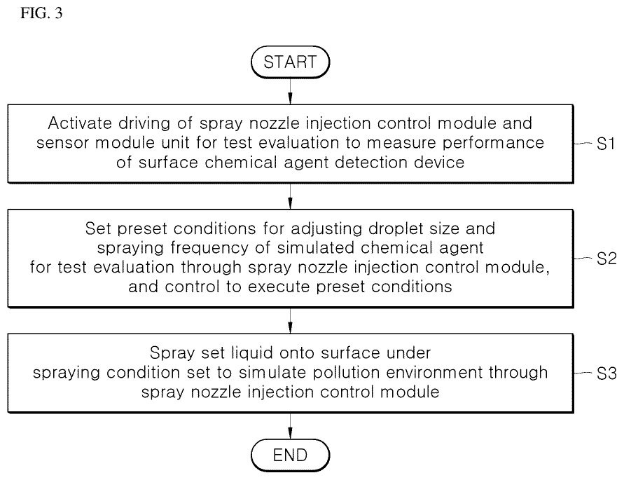

FIG. 3 is a flowchart of the surface pollution environment precision simulation system using uniform droplet dropping according to exemplary embodiments of the present disclosure.

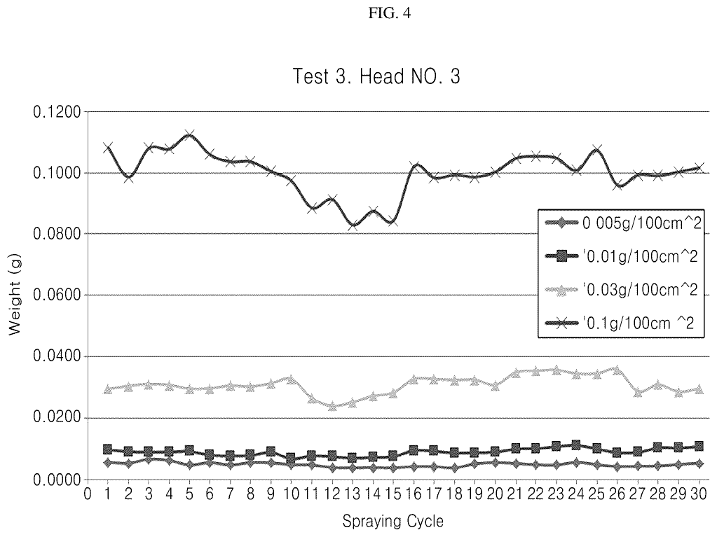

FIG. 4 is a graph illustrating reproducibility results of droplet pollution environment construction using distilled water according to one exemplary embodiment of the present disclosure.

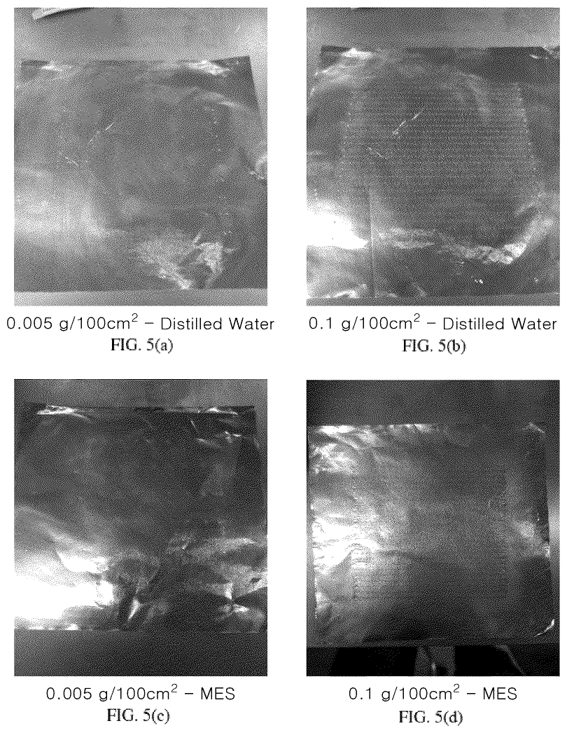

FIGS. 5(a) to 5(d) are actual photographs showing droplets sprayed and dropped under minimum and maximum spraying conditions of Methyl Salicylate (MES), a simulated chemical agent tested according to exemplary embodiments of the present disclosure.

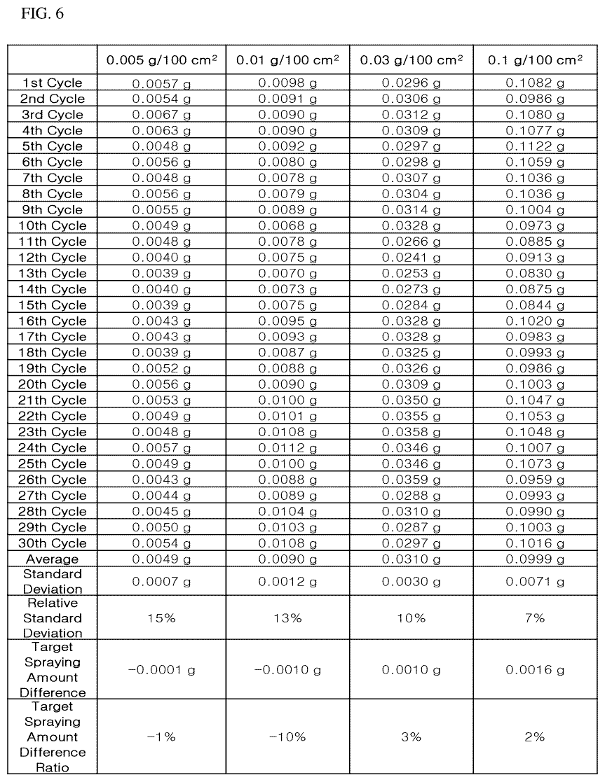

FIG. 6 is a list illustrating spraying results based on target values using distilled water according to one exemplary embodiment of the present disclosure.

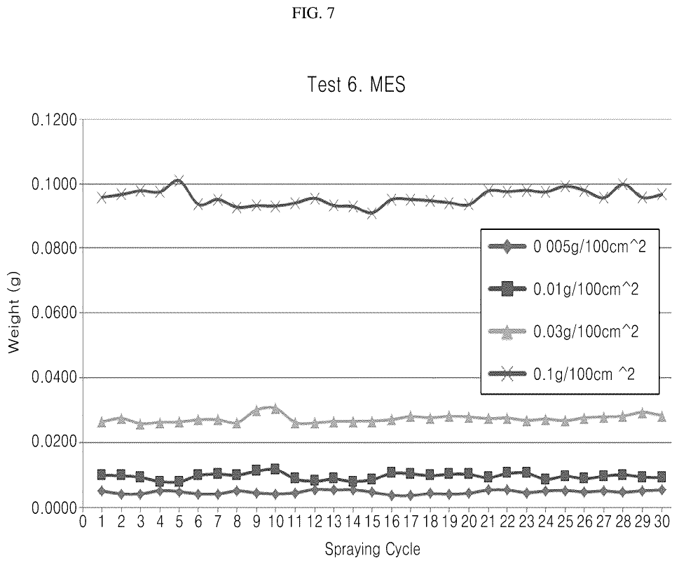

FIG. 7 is a graph illustrating reproducibility results of droplet pollution environment construction using Methyl Salicylate (MES) according to another exemplary embodiment of the present disclosure.

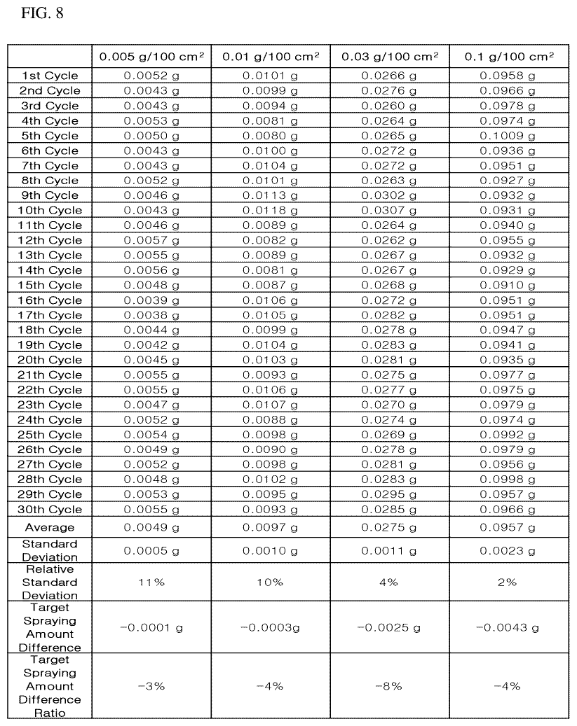

FIG. 8 is a list illustrating spraying results based on target values using Methyl Salicylate according to another exemplary embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Moreover, one or more “unit” and/or “module” described in this specification can be implemented via a non-transitory memory (not shown) and a processor (not shown). The memory is configured to store data concerning algorithms designed to control the operation of system components according to exemplary embodiments of the present disclosure, or software instructions that implement these algorithms. The processor is configured to perform the operations described below using the data stored in the memory. Here, the memory and the processor may be implemented as separate chips. Alternatively, the memory and the processor may be implemented as a single integrated chip. The processor may take the form of one or more processors.

Furthermore, in the specification of the present disclosure, terms such as “unit,” “device,” “module,” “means,” and “apparatus,” if used, refer to a unit capable of processing one or more functions or operations and should be understood to be implementable in hardware, software, or a combination of hardware and software.

As will be understood by those skilled in the art, the realization of all or some of the steps of the above exemplary embodiments may be accomplished through hardware, or may be accomplished by directing the relevant hardware through a computer program. The computer program may include instructions for executing some or all of the steps of the method, the computer program may be stored on a readable storage medium, and the storage medium may be any form of storage medium.

As used herein, the term “surface” includes a ground surface unless otherwise specified, and may refer to various surfaces such as a land surface, ground, pavement, or the like. Hereinafter, exemplary embodiments of the present disclosure will be described in detail with reference to related drawings.

FIG. 2 is a conceptual diagram illustrating a surface pollution environment precision simulation system using uniform droplet dropping according to an exemplary embodiment of the present disclosure.

Referring to FIG. 2, a surface pollution environment precision simulation system using uniform droplet dropping according to the present disclosure includes:
a spray nozzle unit 2 configured to spray a set liquid onto a ground surface 1 under a spraying condition set to simulate a pollution environment;
a spray nozzle injection control module 3 configured to set and control preset conditions such as droplet size and spraying frequency of a liquid, for example, a simulated chemical agent for test evaluation, sprayed through the spray nozzle unit 2;
a pressure control module 4 configured to control a pressure of the liquid sprayed through the spray nozzle unit 2;
a pressure supply unit 5 configured to supply the set pressure to the spray nozzle unit via the pressure control module 4; and
a main control unit 7 configured to comprehensively control functions of the surface pollution environment precision simulation system 6, including the spray nozzle injection control module 3.

In addition, at one side of the surface pollution environment precision simulation system 6, for example, at one side of the pressure supply unit 5 and the spray nozzle unit 2, a plurality of sensor module units 8 are further provided, the plurality of sensor module units 8 being configured to detect pressure supply by the pressure supply unit 5, spraying by the spray nozzle unit 2, or reproducibility of droplets simulated on the ground surface 1, and to transmit the detected information to the main control unit 7.

In addition, the spray nozzle injection control module 3 further includes a droplet spraying condition setting function configured to set, as preset conditions for adjusting droplet size and spraying frequency, factors including, for example, needle lift, needle rising time, nozzle open time, droplet falling time, delay, and drop count, and to operate and control the spray nozzle injection control module 3 according to the preset conditions to adjust the droplet size and the spraying frequency.

Furthermore, the spray nozzle injection control module 3 further includes a spraying amount adjustment function configured to perform adjustment of a spraying amount. In this case, the spraying amount adjustment function is configured to spray a sample in a grid structure of a uniform size according to variable settings when spraying the sample. The grid structure of the spraying amount adjustment function is controlled by variables including delay, grid distance, and grid size. In the delay, the sample is sprayed at a set time interval: in the grid distance, the sample is sprayed at a set physical spacing; and in the grid size, the sample is sprayed a set number of times, thereby setting X-axis size and Y-axis size of an entire grid structure, the spraying amount adjustment function further including an entire grid structure setting function.

The main control unit 7 further includes a droplet control function configured to control a form and a range of droplets to be sprayed.

Here, the droplet control function includes at least one selected from the group consisting of a general mode, a grid mode, and an in-flight dosing mode.

In addition, the main control unit 7 controls functions of the spray nozzle injection control module 3 and the pressure control module 4 to set spraying conditions such that an amount of liquid dropped per unit area (m²) is any one of, for example, 0.5 g, 1 g, 3 g, or 10 g, and performs precision simulation control by detecting and confirming reproducibility through the sensor module unit 8 to precisely simulate a pollution environment for test evaluation on the ground surface 1.

Meanwhile, the surface pollution environment precision simulation system 6 according to the present disclosure may also use a device similar to the Autodrop Compact, an automatic ground surface contamination simulation droplet dropping device by Microdrop Technologies, which is capable of highly precise droplet ejection to simulate a ground surface liquid agent spraying contamination environment.

The surface pollution environment precision simulation system 6 according to one exemplary embodiment of the present disclosure may be mounted, for example, on a vehicle or a mobile body (not shown) provided with a fixing assembly 9.

In addition, a spraying angle of the spray nozzle unit 2 may be adjusted by movement of a hinge driving means 10 controlled by the spray nozzle injection control module 3, for example, which is mounted on one side of the fixing assembly 9.

Meanwhile, the main control unit 7 further includes a spraying pressure control function configured to supply a set pressure to the spray nozzle unit 2 via the pressure control module 4 through the pressure supply unit 5, and simultaneously drive the pressure control module 4 to control the pressure of the liquid sprayed through the spray nozzle unit 2 according to set conditions.

In addition, the spray nozzle unit 2 and the spray nozzle injection control module 3 may further be configured as a droplet dispenser module including, for example, at least one selected from the group consisting of an inkjet type, jet type, mono type, and screw type.

Hereinafter, a control method according to another exemplary embodiment of the present disclosure having the configuration as described above will be described.

FIG. 3 is a flowchart of the surface pollution environment precision simulation system using uniform droplet dropping according to exemplary embodiments of the present disclosure.

Referring to FIG. 3, the method according to the present disclosure includes:
a first step (S1) in which the main control unit activates driving of the spray nozzle injection control module and the sensor module unit for test evaluation to measure the performance of a ground surface chemical agent detection device;
a second step (S2), after the first step (S1), in which the main control unit sets preset conditions through the spray nozzle injection control module for adjusting droplet size and spraying frequency of a simulated chemical agent for test evaluation, and controls the spray nozzle injection control module so that the preset conditions are executed; and
a third step (S3), after the second step (S2), in which the main control unit controls the spray nozzle injection control module to spray a set liquid onto the ground surface through the spray nozzle unit under a spraying condition set to simulate a pollution environment.

In addition, the second step (S2) further includes a droplet spraying condition setting step.

Here, under control of the main control unit, the spray nozzle injection control module sets factors as preset conditions for adjusting droplet size and spraying frequency, the factors including needle lift, needle rising time, nozzle open time, droplet falling time, delay, and drop count,
and operates and controls the spray nozzle injection control module according to the preset conditions to adjust the droplet size and the spraying frequency.

Furthermore, the second step (S2) further includes a spraying amount adjustment step.

Here, under control of the main control unit, the spray nozzle injection control module performs adjustment of a spraying amount.

In the spraying amount adjustment step, when spraying a sample, the sample is sprayed in a grid structure of a uniform size according to variable settings.

In addition, the spraying amount adjustment step further includes a grid structure control step configured to control the grid structure based on variables including delay, grid distance, and grid size.

In the grid structure control step, the sample is sprayed at a time interval set in the delay, at a physical spacing set in the grid distance, and a number of times set in the grid size.

Thereby, the grid structure control step may further include a grid structure setting step of setting X-axis size and Y-axis size of the entire grid structure.

In addition, the second step (S2) further includes a spraying angle adjustment step.

Here, under control of the main control unit, a spraying angle of the spray nozzle unit is adjusted by movement of a hinge driving means controlled by the spray nozzle injection control module mounted on one side of a fixing assembly.

The third step (S3) further includes a spraying pressure control step.

Here, the main control unit supplies a set pressure to the spray nozzle unit via the pressure control module through the pressure supply unit. Simultaneously, the main control unit drives the pressure control module to control the pressure of the liquid sprayed through the spray nozzle unit according to set conditions.

In addition, the third step (S3) further includes a droplet control function step in which the main control unit controls a form and a range of droplets to be sprayed.

Here, the droplet control function step includes a droplet control element step including at least one element selected from the group consisting of a general mode, a grid mode, and an in-flight dosing mode.

In addition, the third step (S3) further includes a precision simulation control step.

Here, the main control unit controls functions of the spray nozzle injection control module and the pressure control module to set spraying conditions such that an amount of liquid dropped per unit area (m²) is, for example, 0.5 g, 1 g, 3 g, or 10 g.

In addition, in the precision simulation control step, the main control unit detects and confirms reproducibility through the sensor module unit to precisely simulate a pollution environment for test evaluation on the ground surface.

Meanwhile, the surface pollution environment precision simulation system according to the present disclosure may also use a device similar to the Autodrop Compact, an automatic ground surface contamination simulation droplet dropping device by Microdrop Technologies, which is capable of highly precise droplet ejection to simulate a ground surface liquid agent spraying contamination environment.

The control method for the surface pollution environment precision simulation system according to one exemplary embodiment of the present disclosure may also be implemented, for example, in a vehicle or a mobile body (not shown) provided with a fixing assembly.

In other words, the main control unit 7 of the surface pollution environment precision simulation system 6 using uniform droplet dropping according to one embodiment of the present disclosure activates driving of the spray nozzle injection control module 3 and the sensor module unit 8 for test evaluation to measure the performance of a surface chemical agent detection device. For example, a surface pollution test evaluation simulation test is performed by designing spraying conditions based on water (distilled water) and a simulated chemical agent, Methyl Salicylate (MES), as shown in [Table 1] below.

That is, the main control unit 7 sets preset conditions for adjusting droplet size and spraying frequency of a simulated chemical agent for test evaluation through the spray nozzle injection control module 3 as shown in [Table 1] below, and controls the spray nozzle injection control module 3 so that the preset conditions are executed.

Meanwhile, after setting the preset conditions as described above, the main control unit 7 controls the spray nozzle injection control module 3 such that the spray nozzle unit 2 sprays a set liquid onto the ground surface 1 under the spraying condition set to simulate a pollution environment.

In the process of setting the preset conditions, the spray nozzle injection control module 3, under control of the main control unit 7, sets factors as preset conditions for adjusting droplet size and spraying frequency, the factors including needle lift, needle rising time, nozzle open time, droplet falling time, delay, and drop count, and operates and controls the spray nozzle injection control module 3 according to the preset conditions to adjust the droplet size and the spraying frequency.

TABLE 1

| Module | Item | | Function |
|---|---|---|---|
| Controller | Pressure Out | | On |
| | Pressure | | 0.5 |
| | Head | Needle lift (%) | 50 |
| | Option | Rising Time (ms) | 0.5 |
| | | Open Time (ms) | 0.5 |
| | | Falling Time (ms) | 0.5 |
| | | Delay (ms) | 15~100 |
| | | Drop Count | 10 |
| S/W | General | Relative to Reference | Check Out |
| | | Reference Offset | Check Out |
| | | Cont Dosing | Check Out |
| | | Type | grid |
| | | In Flight Dosing | Check |
| | Grid | Type | grid |
| | | grid Pattern | Pattern2 |

| | | |
|---|---|---|
| Grid Distance (mm) | x | 20, 12.5, 10, 6.25, 4 |
| | y | 20, 12.5, 10, 6.25, 4 |
| Grid Size | x | 5, 8, 10, 16, 25 |
| | y | 5, 8, 10, 16, 25 |

| | | |
|---|---|---|
| | In Flight Dosing | Check |
| In Flight | Type | grid |
| Dosing | In Flight Dosing | Check |

| | | |
|---|---|---|
| Speed | x | 100.00 |
| (mm/s) | y | 100.00 |

| | | |
|---|---|---|
| | Acceleration ramp. | 0.00, 0.00 |
| | In Flight Dosing | Check |
| Head | Head No. 1 Active | Check Out |
| Option | Head No. 2 Active | Check or Check Out |
| | Head No. 3 Active | Check or Check Out |

In the process of setting the preset conditions, the spray nozzle injection control module 3 may also perform adjustment of a spraying amount under control of the main control unit 7.

During the spraying amount adjustment process, the spray nozzle injection control module 3, under control of the main control unit 7, sprays a sample in a grid structure of a uniform size according to variable settings when spraying the sample, and controls the grid structure based on variables including delay, grid distance, and grid size.

In addition, under control of the main control unit 7, the spray nozzle injection control module 3 controls a spraying angle of the spray nozzle unit 2 by movement of a hinge driving means 10 controlled by the spray nozzle injection control module 3 mounted on one side of the fixing assembly 9.

In the grid structure control process, the spray nozzle injection control module 3 sprays the sample at a time interval set in the delay, at a physical spacing set in the grid distance, and a number of times set in the grid size, thereby setting X-axis size and Y-axis size of the entire grid structure.

Meanwhile, during the process, the main control unit 7 supplies a set pressure to the spray nozzle unit 2 via the pressure control module 4 through the pressure supply unit 5, and simultaneously drives the pressure control module 4 to control the pressure of the liquid sprayed through the spray nozzle unit 2 according to set conditions.

In addition, the main control unit 7 further executes a droplet control function configured to control a form and a range of droplets to be sprayed.

Here, the droplet control function is executed including at least one element selected from the group consisting of a general mode, a grid mode, and an in-flight dosing mode, as shown in Table 1.

Furthermore, the main control unit 7 controls functions of the spray nozzle injection control module 3 and the pressure control module 4 to set spraying conditions such that an amount of liquid dropped per unit area (m²) is, for example, 0.5 g, 1 g, 3 g, or 10 g as shown in Table 2, and controls the system to precisely simulate a pollution environment for test evaluation on the ground surface 1 by detecting and confirming reproducibility through the sensor module unit 8.

TABLE 2

| Target Surface | | | | | | | |
|---|---|---|---|---|---|---|---|
| Contamination | | | Target Spraying | | | Grid | |
| Level | | Spraying Area | Amount | | Grid | Distance(mm) | Delay(ms) |
| 0.5 | g/m² | 10 × 10 cm | 0.005 | g/100 cm² | 10 × 10 | 10 | 100 |
| 1 | g/m² | 10 × 10 cm | 0.01 | g/100 cm² | 10 × 10 | 10 | 50 |
| 3 | g/m² | 10 × 10 cm | 0.03 | g/100 cm² | 25 × 25 | 4 | 50 |
| 10 | g/m² | 10 × 10 cm | 0.1 | g/100 cm² | 25 × 25 | 4 | 15 |

Here, Table 2 sets detailed spraying conditions according to one exemplary embodiment, particularly specifying detailed spraying conditions based on distilled water as a reference for the target value.

For example, while performing the simulation test evaluation according to one exemplary embodiment, the main control unit 7 was able to obtain 30-cycle results under each spraying condition as shown in Table 2, specifically as illustrated in FIG. 4, FIGS. 5(a) to 5(d), and FIG. 6.

At this time, the main control unit 7 confirmed that, under each condition, there was a difference of approximately 0.0001 g to 0.0016 g from the target spraying amount, and that reproducibility was observed with a relative standard deviation of up to approximately 15%.

Although an error rate of about 15% was observed, the absolute difference was 0.0001 g, which is equivalent to the resolution of the balance, and was therefore considered an acceptable error. Accordingly, it was confirmed that the spraying reproducibility intended by the present disclosure is satisfactory.

Here, Table 3 below is a result chart showing the spraying results based on distilled water as a reference according to one embodiment of the present disclosure.

Meanwhile, in another exemplary embodiment of the present disclosure, the main control unit 7 of the surface pollution environment precision simulation system 6 using uniform droplet dropping sets detailed spraying conditions as shown in Table 3 below, wherein, in particular, the detailed spraying conditions in this embodiment are based on Methyl Salicylate as a reference for the target value.

TABLE 3

| Target Surface | | | | | | | |
|---|---|---|---|---|---|---|---|
| Contamination | | | Target Spraying | | | Grid | |
| Level | | Spraying Area | Amount | | Grid | Distance(mm) | Delay(ms) |
| 0.5 | g/m² | 10 × 10 cm | 0.005 | g/100 cm² | 5 × 5 | 20 | 100 |
| 1 | g/m² | 10 × 10 cm | 0.01 | g/100 cm² | 8 × 8 | 12.5 | 75 |
| 3 | g/m² | 10 × 10 cm | 0.03 | g/100 cm² | 16 × 16 | 6.25 | 60 |
| 10 | g/m² | 10 × 10 cm | 0.1 | g/100 cm² | 25 × 25 | 4 | 18 |

For example, while performing the simulation test evaluation according to another embodiment, the main control unit 7 was able to obtain 30-cycle results under each spraying condition as shown in Table 3, specifically as illustrated in FIG. 7, FIGS. 5(a) to 5(d), and FIG. 8.

At that time, it was confirmed that there was a difference of approximately 0.0001 g to 0.0043 g from the target spraying amount under each condition, and reproducibility was observed with a relative standard deviation of up to approximately 11%. It was thereby confirmed that the surface pollution environment simulation for test evaluation as intended in the present disclosure is satisfactory.

Meanwhile, the surface pollution environment precision simulation system 6 according to the present disclosure may also use a device similar to the Autodrop Compact, an automatic ground surface contamination simulation droplet dropping device by Microdrop Technologies, which is capable of highly precise droplet ejection to simulate a ground surface liquid agent spraying contamination environment.

The control method for the surface pollution environment precision simulation system 6 according to one exemplary embodiment of the present disclosure may also be implemented, for example, in a vehicle or a mobile body (not shown) provided with a fixing assembly 9.

As described above, according to the present disclosure, by controlling an inkjet-type droplet generation device such that uniform droplet dropping is performed within a contaminated area according to set conditions, it is possible to precisely simulate and control a field pollution environment required in test and evaluation procedures for chemical agents or the like.

In addition, according to the present disclosure, by precisely controlling and implementing a surface pollution environment of a chemical agent required in test and evaluation through variable control such as spraying amount, droplet size, spraying frequency, and software operation of the simulation equipment, residual amounts do not remain at the equipment outlet, thereby significantly improving the efficiency and reliability of a test and evaluation method for measuring the performance of surface chemical agent detection equipment and devices.

Therefore, according to the control method of one embodiment of the present disclosure as described above, it is possible to precisely control and simulate droplet dropping of a chemical agent and a reference contamination concentration for performance verification and measurement of surface chemical agent detection equipment and devices.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMBERS

1: surface
2: spray nozzle unit
3: spray nozzle injection control module
4: pressure control module
5: pressure supply unit
6: surface pollution environment precision simulation system
7: main control unit
8: sensor module unit
9: fixing assembly

What is claimed is:

1. A surface pollution environment precision simulation system using uniform droplet dropping, comprising:
a spray nozzle unit configured to spray liquid onto a surface under a spraying condition set to simulate a pollution environment;
a spray nozzle injection control module configured to set and control the spraying condition of a simulated chemical agent for test evaluation through the spray nozzle unit, the spraying condition including at least one selected from the group consisting of droplet size and spraying frequency;
a pressure control module configured to control pressure of the liquid sprayed by the spray nozzle unit;
a pressure supply unit configured to supply the pressure to the spray nozzle unit via the pressure control module; and
a main control unit configured to comprehensively control functions of the surface pollution environment precision simulation system including the spray nozzle injection control module.

2. The surface pollution environment precision simulation system of claim 1,
wherein the spray nozzle injection control module further includes a droplet spraying condition setting function configured to set factors including at least one selected from the group consisting of needle lift, needle rising time, nozzle open time, droplet falling time, delay, and drop count, for adjusting droplet size and spraying frequency, and
wherein the spray nozzle injection control module is operated and controlled depending on the factors to adjust the droplet size and the spraying frequency.

3. The surface pollution environment precision simulation system of claim 1,
wherein the spray nozzle injection control module further includes a spraying amount adjustment function configured to adjust a spraying amount, and
wherein, in the spraying amount adjustment function, the liquid is sprayed in a grid structure of a uniform size depending on setting of variables.

4. The surface pollution environment precision simulation system of claim 3,
wherein the spraying amount adjustment function further includes a grid structure setting function configured to set X-axis size and Y-axis size of the grid structure,
wherein the grid structure setting function controls the variables including at least one selected from the group consisting of delay, grid distance, and grid size,
wherein the delay refers to a time interval at which the liquid is sprayed,
wherein the grid distance refers to a physical spacing at which the liquid is sprayed, and
wherein the grid size refers to a number of times the liquid is sprayed to form the grid structure.

5. The surface pollution environment precision simulation system of claim 1,
wherein the main control unit further includes a droplet control function configured to control a form and a range of droplets sprayed, and
wherein the droplet control function includes at least one selected from the group consisting of a general mode, a grid mode, and an in-flight dosing mode.

6. The surface pollution environment precision simulation system of claim 1,
wherein the main control unit further includes a precision simulation control function configured to control functions of the spray nozzle injection control module and the pressure control module, and
wherein, in the precision simulation control function, the spraying condition is set such that an amount of the liquid dropped per unit area (m²) is any one of 0.5 g, 1 g, 3 g, or 10 g, and a sensor module unit is provided to detect and confirm reproducibility, in order to precisely simulate the pollution environment for test evaluation on the surface.

7. The surface pollution environment precision simulation system of claim 1,
wherein the surface pollution environment precision simulation system uses a surface contamination simulation automatic droplet dropping device (Autodrop Compact) to simulate a contamination environment sprayed with a liquid agent.

8. The surface pollution environment precision simulation system of claim 1,
wherein a spraying angle of the spray nozzle unit is controlled by a hinge driving means, and the hinge driving means is controlled by the spray nozzle injection control module.

9. The surface pollution environment precision simulation system of claim 1,
wherein the main control unit further includes a spraying pressure control function configured to supply a set pressure to the spray nozzle unit via the pressure control module by the pressure supply unit, and simultaneously drive the pressure control module to control the pressure of the liquid sprayed by the spray nozzle unit according to set conditions.

10. The surface pollution environment precision simulation system of claim 1,
wherein the spray nozzle unit and the spray nozzle injection control module are configured as a droplet dispenser module including at least one selected from the group consisting of inkjet, jet, mono, and screw types.

11. The surface pollution environment precision simulation system of claim 1,
wherein a plurality of sensor module units are provided at one side of the pressure supply unit and the spray nozzle unit, and
wherein the plurality of sensor module units are configured to detect pressure supply by the pressure supply unit, spraying by the spray nozzle unit, or reproducibility of droplets simulated on the surface, and to transmit the detected information to the main control unit.

12. A control method for a surface pollution environment precision simulation system using uniform droplet dropping, comprising:
a first step of activating, by a main control unit, driving of a spray nozzle injection control module and a sensor module unit for test evaluation to measure performance of a surface chemical agent detection device;
a second step of setting, after the first step, by the main control unit, preset conditions for adjusting droplet size and spraying frequency of a simulated chemical agent for test evaluation through the spray nozzle injection control module, and controlling the spray nozzle injection control module to execute the preset conditions; and
a third step of controlling, after the second step, by the main control unit, a spray nozzle unit to spray a set liquid onto a surface under a spraying condition set to simulate a pollution environment through the spray nozzle injection control module.

13. The control method of claim 12,
wherein the second step further includes a droplet spraying condition setting step,
wherein, in the droplet spraying condition setting step, under control of the main control unit, the spray nozzle injection control module sets factors including at least one selected from the group consisting of needle lift, needle rising time, nozzle open time, droplet falling time, delay, and drop count, for adjusting droplet size and spraying frequency, and
wherein the spray nozzle injection control module is operated and controlled depending on the factors to adjust the droplet size and the spraying frequency.

14. The control method of claim 12,
wherein the second step further includes a spraying amount adjustment step, and
wherein, in the spraying amount adjustment step, under control of the main control unit, the spray nozzle injection control module performs adjustment of a spraying amount.

15. The control method of claim 14,
wherein the spraying amount adjustment step further includes a grid structure control step,
wherein, in the grid structure control step, when spraying the liquid, the liquid is sprayed in a grid structure of a uniform size depending on variable settings, and
wherein the grid structure is controlled based on variables including at least one selected from the group consisting of delay, grid distance, and grid size.

16. The control method of claim 15,
wherein the grid structure control step further includes a grid structure setting step of setting X-axis size and Y-axis size of the grid structure, and
wherein, in the grid structure setting step, the liquid is sprayed at a time interval set in the delay, at a physical spacing set in the grid distance, and a number of times set in the grid size.

17. The control method of claim 12,
wherein the second step further includes a spraying angle adjustment step, and
wherein, in the spraying angle adjustment step, under control of the main control unit, a spraying angle of the spray nozzle unit is adjusted by movement of a hinge driving means controlled by the spray nozzle injection control module mounted at one side of a fixing assembly.

18. The control method of claim 12,
wherein the third step further includes a spraying pressure control step, and
wherein, in the spraying pressure control step, the main control unit supplies a set pressure to the spray nozzle unit via the pressure control module by the pressure supply unit, and simultaneously drives the pressure control module to control the pressure of the liquid sprayed by the spray nozzle unit according to set conditions.

19. The control method of claim 12,
wherein the third step further includes a droplet control step in which the main control unit includes a droplet control function configured to control a form and a range of droplets sprayed, and
wherein the droplet control function includes at least one selected from the group consisting of a general mode, a grid mode, and an in-flight dosing mode.

20. The control method of claim 12,
wherein the third step further includes a precision simulation control step in which the main control unit controls functions of the spray nozzle injection control module and the pressure control module to set the spraying condition such that an amount of the liquid dropped per unit area (m²) is any one of 0.5 g, 1 g, 3 g, or 10 g, and
wherein, in the precision simulation control step, the main control unit detects and confirms reproducibility through the sensor module unit to precisely simulate a pollution environment for test evaluation on the surface.
